(19) United States
(12) Patent Application Publication
(10) Pub. No.: US 2017/0170682 A1
(43) Pub. Date: Jun. 15, 2017

(54) DISTRIBUTED WIRELESS SENSOR NETWORK AND METHODS OF USING THE SAME

(71) Applicant: Siemens Energy, Inc., Orlando, FL (US)

(72) Inventor: Joshua S. McConkey, Orlando, FL (US)

(21) Appl. No.: 14/966,680

(22) Filed: Dec. 11, 2015

(51) Int. Cl. H02J 7/35; H02J 7/04; H02J 7/02

(52) U.S. Cl. CPC H02J 7/355; H02J 7/025; H02J 7/041; H02J 7/045

(57) ABSTRACT

A wireless monitoring system and method of using the same is provided. The monitoring system includes a controller, wireless node assembly (WNA), and light emitting means. The controller is connected to the light emitting means for controlling its operation in response to messages received from the WNA. The messages may include information identifying the location of the WNA, and the power remaining in its power source. In response to the received message, the controller is configured to determine whether the power remaining is below a predetermined value requiring the power source to be recharged. Upon determining that the power source needs recharging, the controller activates the light emitting means such that a light energy is emitted and is in the line-of-sight of a sensor power adapter connected to the power source. The sensor power adapter is configured to convert the light energy into electricity for recharging the power source.

### TECHNICAL FIELD

The present disclosure relates generally to networked devices and systems, and more particularly, to a wireless monitoring system for use with, e.g., a power generation unit, and methods of using the same.

### BACKGROUND

Distributed sensor networks have been used for monitoring various parameters of power generation units within a power generation plant, e.g., to avoid possible system failures. These distributed sensor networks typically include wired sensors, which may be installed on the same power and signal lines as the power generation units. These wired networks typically carries high installation costs due to the need for running additional power and signal lines, e.g., to each sensor. Additionally, the reliability of these wired networks is questionable, as power failures and faults within the power generation plant will effectively cause the wired sensors to fail.

Battery powered solutions have been provided, e.g., by replacing wired sensors with wireless sensors, to reduce costs associated with wired networks, and to prevent failures resulting from power and signal loss within the power plant. However, these battery power solutions have reliability issues as well, as the batteries powering these wireless sensors lasts for a limited amount of time, which results in the wireless sensor coming offline. Because these wireless sensors are needed for monitoring the power generation unit, e.g., to avoid system failures, it is important to provide a more reliable system. Therefore, there remains a need for systems and methods that provide a more reliable monitoring system.

### SUMMARY

An object of the present disclosure is to provide an improved monitoring system for one or more power generation units, e.g., gas turbine, steam turbine, generator or the like, that is more reliable than systems relying on batteries, or wired power and signal lines.

In one embodiment, a power generation plant with wireless monitoring system is provided. The power generation plant may include one or more power generation units, e.g., gas turbine engine, generator, etc., and a wireless monitoring system. The power generation units may include one or more sensors for sensing one or more parameters of the power generation unit and for transmitting the senses parameters to the wireless monitoring system. The wireless monitoring system may be a distributed wireless sensor network having one or more wireless node assemblies distributed throughout the plant and proximate to the power generation units for receiving the sensed parameters of the power generation unit. The wireless monitoring system may further include a controller operably connected to a light emitting means and the wireless node assembly. The controller may be configured to receive the sensed parameters of the power generation unit from the wireless node assembly, and to receive one or more parameters of the wireless node assembly. The one or more parameters of the wireless node assembly may identify, e.g., the location of the wireless node assembly or other device of the wireless monitoring system, and the power level remaining in the wireless node assembly, or more particularly, the wireless node assembly's sensor power source.

The controller may further be configured to identify the parameters of the wireless node assembly, and to determine if the identified parameters indicate that the energy level of the sensor power source is within a predefined range requiring that the sensor power source be recharge. Upon determining that the energy level is within the predefined range, the controller may be configured to generate and transmit one or more signals or commands to activate the light emitting means. The activated light emitting means may be within the purview of the wireless node assembly, e.g., positioned above and/or proximate to the wireless node assembly, or more particularly, positioned such that any light energy emitted from the light energy means is within the line-of-sight of a sensor power adapter of the wireless node assembly. The sensor power adapter may be operably connected to the sensor power source, and operably configured to convert the light energy into, e.g., electricity, for recharging the sensor power source.

In yet a further embodiment, the controller may further be configured to deactivate the activated light emitting means upon determining that the energy level of the wireless node assembly is outside of the predetermined range requiring recharging. To determine whether the energy level is outside the predetermined range, the controller may receive a subsequent message, via the wireless node assembly, indicating that the energy level is outside the range. Thereafter, the controller may generate and transmit a command to deactivate the light emitting means. In yet a further embodiment, the activated light emitting means may be deactivated after a predetermined amount of time has elapsed since activation.

### BRIEF DESCRIPTION OF THE DRAWINGS

FIG. 1 illustrates an exemplary embodiment of a power production plant with wireless monitoring system in accordance with the disclosure provided herein;

FIG. 2 illustrates an exemplary embodiment of the a controller and light emitting means of the wireless monitoring system, and in accordance with the disclosure provided herein;

FIG. 3 illustrates an exemplary embodiment of a controller and wireless node assembly of the wireless monitoring system, and in accordance with the disclosure provided herein; and

FIG. 4 illustrates an exemplary flowchart of a process performed by an embodiment of a controller of the monitoring system in accordance with the disclosure provided herein.

### DETAILED DESCRIPTION

The components and materials described hereinafter as making up the various embodiments are intended to be illustrative and not restrictive. Many suitable components and materials that would perform the same or a similar function as the materials described herein are intended to be embraced within the scope of embodiments of the present invention.

In general, the computing systems and devices described herein may be assembled by a number of computing components and circuitry such as, for example, one or more processors (e.g., Intel®, AMD®, Samsung®) in communication with memory or other storage medium. The memory may be Random Access Memory (RAM), flashable or non-flashable Read Only Memory (ROM), hard disk drives, flash drives, or any other types of memory known to persons of ordinary skill in the art and having storing capabilities. The computing systems and devices may also utilize cloud computing technologies to facilitate several functions, e.g., storage capabilities, executing program instruction, etc. The computing systems and devices may further include one or more communication components such as, for example, one or more network interface cards (NIC) or circuitry having analogous functionality, one or more one way or multi-directional ports (e.g., bi-directional auxiliary port, universal serial bus (USB) port, etc.), in addition to other hardware and software necessary to implement wired communication with other devices. The communication components may further include wireless transmitters, a receiver (or an integrated transceiver) that may be coupled to broadcasting hardware of the sorts to implement wireless communication within the system, for example, an infrared transceiver, Bluetooth transceiver, or any other wireless communication know to persons of ordinary skill in the art and useful for facilitating the transfer of information.

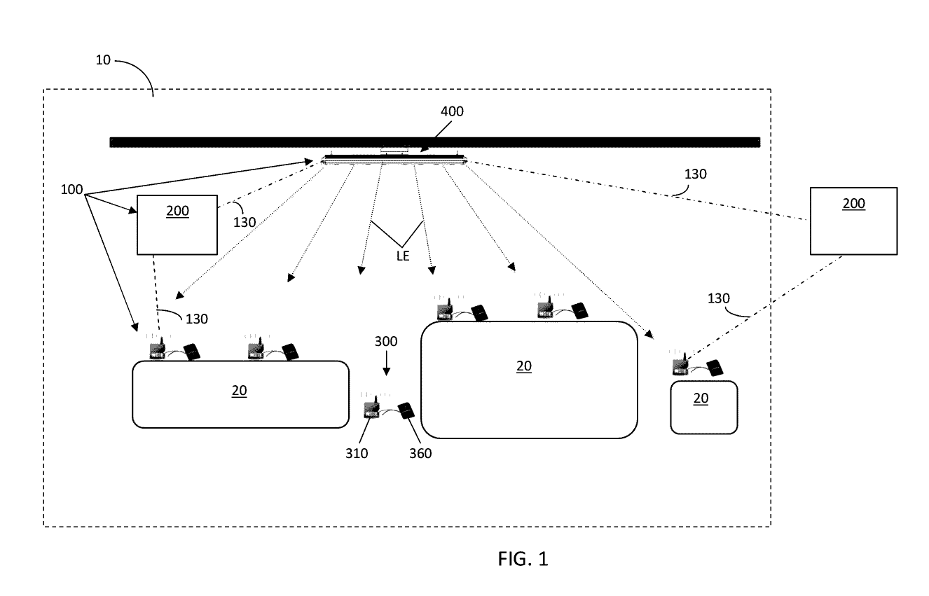

Referring now to the drawings wherein the showings are for purposes of illustrating embodiments of the subject matter herein only and not for limiting the same, FIG. 1 illustrates an exemplary embodiment of a power generation plant 10 with monitoring system (PMS) 100 in accordance with the disclosure provided herein. The power generation plant (PGP) 10 may generally include one or more power generation units (PGU) 20, e.g., steam and/or gas turbine engines, generators, or similar, operably connected to one another and a plant controller (not shown) for generating and distributing power.

Each PGU 20 may include sensors (not shown) for monitoring/sensing various parameters of the PGU 20, and for transmitting data representative of the sensed parameters to the PMS 100. The sensed parameters may include, for example, the temperature within the PGU 20 or surrounding its internal components, vibrations of various pumps, pressures within various line, stress of particular parts, humidity, valve status (on/off), and position indications. The sensed parameters may be transmitted to the PMS 100 via a communications link 130. The communications link 130 may be, e.g., a wired communications link, wireless communications link, or any other communications link known to persons having ordinary skill in the art and configurable to allow for communication and/or interfacing between the devices and/or components within the PGP 10, PGU 20, and PMS 100. Examples of such communication links may include Local Area Networks (LAN), Wide Area Networks (WAN), and Global Area Networks (GAN) having wired or wireless branches. Additionally, network devices/components and/or nodes (e.g., cabling, routers, switches, gateway, etc.) may also be included in the PMS 100 for facilitating the transfer of information within the PMS 100, and between the PMS 100 and the devices within the PP 10, e.g., sensors of the PGU 20.

With continued reference to FIG. 1, the PMS 100 may include one or more hubs or controllers 200 operably connected to one or more wireless node assemblies (WNA) 300 for receiving the sensed parameters of the PGU 20, and one or more parameters of the WNA 300. The PMS 100 may further include one or more a light emitting means 400 operably connected to the controller 200. Each controller 200, WNA 300, and light emitting means 400 may include any combination of the components and/or circuitry described above for facilitating the transfer of information within the PMS 100, and between the PGU 20 and the PMS 100. Additionally, the connection between the controller 200, the WNA 300, and the light emitting means 400 may be via any of the communications links 130 described herein, e.g., a wireless and/or wired connection.

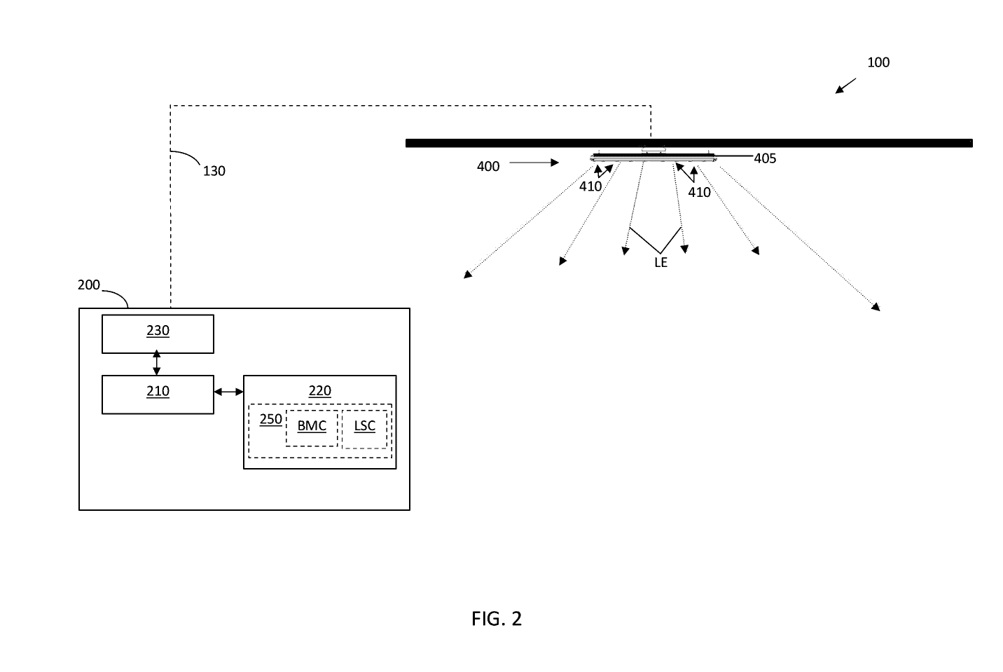

With reference now to FIG. 2, an exemplary embodiment of the controller 200 is provided. The controller 200 may be located within the PGP 10, or at a location remote from the PGP 10. It should also be appreciated that the controller 200 may be part of the general plant controller described above, or its own controller of the PMS 100. In the embodiment of FIG. 2, the controller 200 may include a processing circuit 210 operably connected to and in signal communication with a memory 220 for executing various instructions and/or commands of a controller application (CAP) 250. The CAP 250 may be stored in the memory 220 or other storage medium operably connected to the controller 200, e.g., external hard disk or solid-state drive, or networked drive or device. The CAP 250 may comprise series instructions, which when executed by the processing circuit 210, causes the controller to control one or more devices of the PMS 100 in response to the parameters received from the WNA 300. The series of instructions may include, e.g., instructions for monitoring the status of the WNA 300, and instructions for controlling the operability of the light emitting means 400.

The controller 200 may further include a network interface circuit 230 operably connected to the processing circuit 210 and/or memory 220, and configured for interfacing the controller 200 with any of the devices within the PMS 100 and/or the PGP 10, e.g., the WNA 300 and PGU 20. The network interface circuit 230 may be any of the communication components described herein (e.g., NIC, wireless transceivers etc.) for facilitating the transfer of information between the controller 200 and the devices of the PMS 100 and PGP 10. The transmission of information via the network interface circuit 230 may also be one-directional or multidirectional, e.g., depending on whether the network interface circuit 230 comprises a separate receiver and transmitter circuit, or a transceiver. The controller may also include a user interface 260. The user interface 260 may be any general interface, e.g., a graphical interface (GUI), which receives user input and generates an output, e.g., a displayable output.

With continued reference to FIG. 2, the light emitting means 400 is shown in operable communication with the controller 200, e.g., via the network interface circuit 230. The light emitting means 400 may generally be installed within the PGP 10, e.g., as a fixture in a ceiling of the PGP 10 or proximate thereto, such that the light emitting means 400 may be situated above any devices or units within the PGP 10, and within the purview of one or more of the WNAs 300. In one exemplary embodiment, the light emitting means 400 may be a lighting fixture or lighting assembly (LFA) 400, e.g., a light emitting diode (LED) lighting fixture, operably connected to a power source of within the PGP 10, for supplying power to the LFA 400 and its electrical components. As shown in FIG. 2, the LFA 400 may include a housing 405 having one or more bulbs (e.g., LED bulbs) or bulb assemblies 410 removably attached therein and operable to emit an energy source, e.g., a light energy LE (FIG. 1), therefrom. The bulbs 410 may be disposed within the housing such that light emitted from the bulbs 410 may be without obstruction or substantial obstruction cause by the housing 405 or components attached thereto.

The LFA 400 may further include a microcontroller 420 operably connected to a network interface circuit 430 for processing commands or signals received from the controller 200, via the network interface circuit 430, and in response to the parameters received from by the controller 200 from the WNA 300. The network interface circuit 430 may be similar to the network interface circuit 230 of the controller in that it may be configured for one-directional communication between the controller 200 and the LFA 400, or multi-directional communication as described herein. The LFA 400 may further include a switching circuit 440 operably connected to the microcontroller 420. The switching circuit 440 may be configured to control the operability of each bulb or bulb assembly 410, i.e., the powering on or off each bulb or assembly, in response to commands from the controller 200.

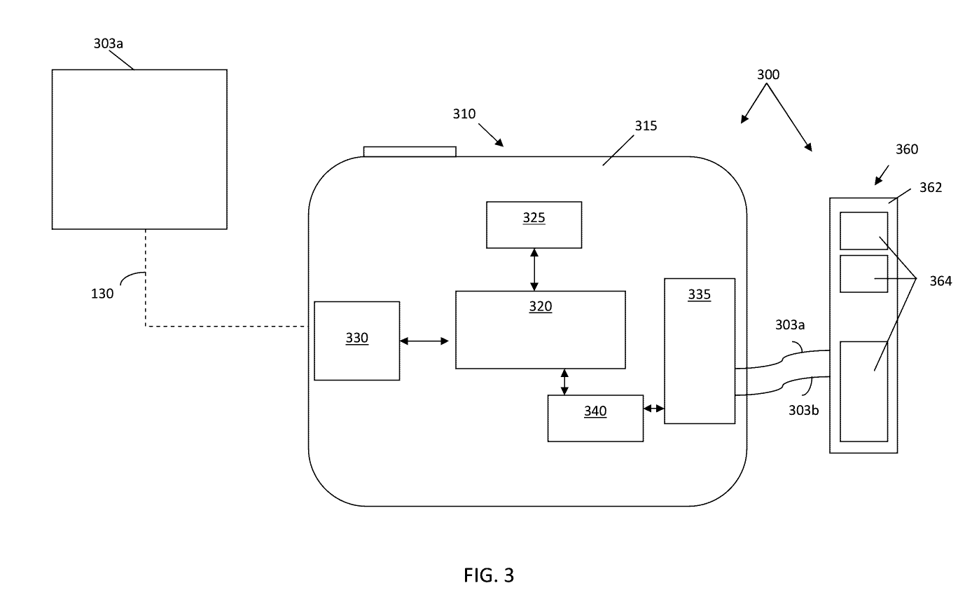

With reference now to FIG. 3, an embodiment of the WNA 300 is provided. The WNA 300 may include may include any combination of the components and/or circuitry described above for facilitating the transfer of information between the WNA 300 and other devices of the PMS 100 and/or the PGP 10, e.g., the controller 200 or PGU 20. In the embodiment of FIG. 3, the WNA 300 may include, at least, a wireless sensor 310 operably connected to a sensor power adapter (SPA) 360. The wireless sensor 310 may include processing circuits for performing various processing operations typical of a sensor and/or processor. The wireless sensor 310 may also contain circuitry for detecting various types of malfunctions that may occur within the wireless sensor, or within (neighboring) wireless sensors 310 operably connected thereto. The wireless sensor 310 may also be configured to receive the sensed parameters from the sensors of the PGU 20, and for transmitting the sensed parameters to the devices of the PMS 100, e.g., the controller 200, or another WNA 300. The SPA 360 may be configured to convert the emitted light energy LE from the bulbs 410 into power (electricity) for charging or recharging the wireless sensor 310, or more particularly, the sensor power source 335.

As shown in FIG. 3, the wireless sensor 310 may include a sensor housing 315. The sensor housing may be adapted to at least partially enclose one or more electrical components therein. The wireless sensor 310 may further include a processing circuit 320, a memory 325, a network interface circuit 330, and a sensor power source 335. The processing circuit 320 may be operably connected to and in signal communication with, e.g., the memory 325 and network interface circuit 330 for performing various processing operations, e.g., receiving and transmitting various parameters. The network interface circuit 330 may be similar to the network interface circuit 230 for the controller 200 in that it may be any of the communication components described herein (e.g., NIC, wireless transceivers etc.) for facilitating the transfer of information between the wireless sensor 310 and the devices of the PMS 100 and PGP 10, e.g., another WNA 300, controller 200 and PGU 20. The sensor power source 335 may be configured to supply power to the components of the wireless sensor 310. In one embodiment, the sensor power source 335 may be, e.g., a battery or battery pack, or other power source known to persons of ordinary skill and configured for powering wireless sensors. The sensor power source 335 may be rechargeable and coupled to one or more conductors (not shown) within the WNA 300 for distributing power throughout the wireless sensor 310, and for receiving power/electricity from, e.g., the SPA 360.

With continue reference to the figures, the wireless sensor 310 may include monitoring circuitry 340 operably connected to the sensor power source 335 and other components, e.g., the memory 325, for monitoring the power remaining in the sensor power source 335, e.g., the battery level, and transmitting the results, e.g., to the controller 200 or second WNA 300. In yet a further embodiment, the functionality of the monitoring circuitry 340, i.e., to identify the status of the sensor power source 335, may reside in the controller 200, e.g., as a battery monitoring circuit BMC (FIG. 2), or in another exemplary embodiment, as a series of instructions of the control of the CAP 250. In this embodiment, the status of the sensor power source 335 need not be transmitted from the WNA 300 to the controller 200.

In operation, the monitoring circuit 340 may continuously, or sequentially, monitor the sensor power source 335 to detect or identify any changes in its energy or power level, e.g., the amount of power remaining as compared to the sensor power source's 335 power capacity. Once the remaining energy level is identified, the identified level may then be transmitted to the controller 200, e.g., via the network interface circuit 330. In one embodiment, the power level may be transmitted to the controller 200 as a battery state, i.e., a status assigned to and representative of the power remaining in the sensor power source 335.

The battery state may be defined via the wireless sensor 310, or in a further embodiment, via the controller 200. Examples of types of battery states may include, e.g., a full state, a partial state, or critical state. In one embodiment, a full-battery state may be representative of a battery having a power level at or proximate to that sensor power source's 335 power capacity, e.g., a battery with 100% power. A partial-battery state may be representative of the sensor power source's 335 power level being around 50% of its power capacity. A critical-battery state may represent less than 25% of power remaining in the sensor power source 335. It should also be appreciated that the detected or identified numerical value for the power level remaining may also be transmitted to the controller 200 as the battery state in another embodiment. The above power level percentages are exemplary in nature, and not for limiting the possible power level values or ranges defining a particular battery state, and that each battery state may be customized to based on ones needs or industry requirements.

With continue reference to the figures, and upon identifying the power level of the sensor power source 335, the controller 200, under the control of the CAP 250, may activate one or more of the LFA 400 in response to the identified power level. In order to activate the LFA 400, the controller 200 may transmit one or more commands to the switching circuit 440. Upon receiving the commands from the controller 200, the switching circuit 440 may activate one or more of the bulbs 410 of the LFA 400, such that light energy LE may be emitted from the bulbs 410 and within the purview of the WNA 300 identified as having a sensor power source 335 with a power level below capacity. It should further be appreciated that the functionality of the switching circuit 440 may also reside in the controller 200, e.g., as a light switching circuit LSC (FIG. 2), or as a series of instruction of the CAP 250.

With continued reference to FIG. 3, in one embodiment for converting the emitted light energy LE, the SPA 360 may be a photovoltaic (PV) panel 362. In this embodiment, the PV panel 362 may include one or more PV cells 364 selectively attached to a support structure or frame 366, such that the PV cells 364 are situated for absorbing the light energy LE, e.g., from the light emitting means 400. The SPA 360 may further comprise one or more wires (303a, 303b) selectively coupled to the PV panel 362 for transferring the absorbed or converted energy from the SPA 360 to the sensor power source 335 for charging the sensor power source 335. The conversion of the absorbed light into electricity may be a direct conversion, i.e., it may occur once the light energy LE is absorbed or strikes the PV cells 364. Once the electricity is transferred to the sensor power source 335, and the power level of the sensor power source 335 is at or near full capacity, the monitoring circuit 340 may transmit the power level of the sensor power source 335 to the controller 200, which may then cause the LFA 400 to deactivate, i.e., turn off, such that light energy LE is no longer being emitted therefrom.

It should also be appreciated, that a transmission of the updated power level may not necessary in an embodiment where the monitoring circuit continuously monitors the sensor power source 335, or where the monitoring is performed in the controller 200. In this embodiment, the status of the sensor power source 335 may be identified by the controller 200, which may control, e.g., power off, the LFA 400 in response to the status of the sensor power source 335.

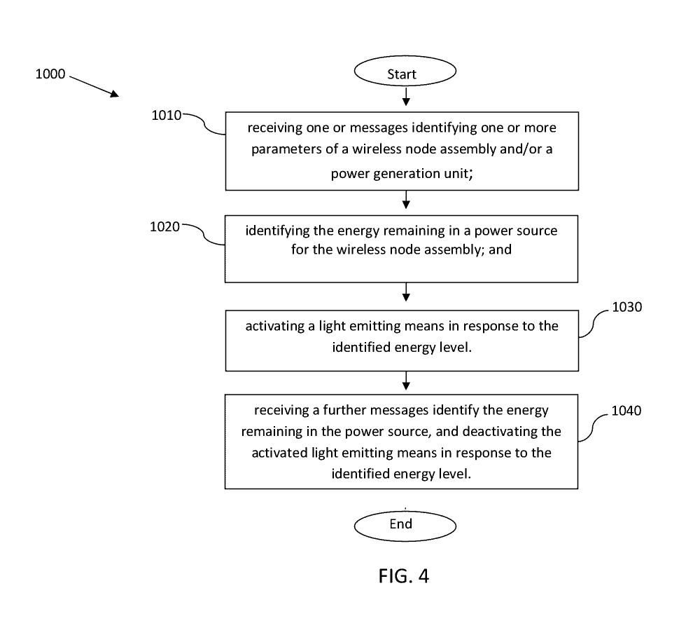

With continued reference to the figures, and now FIG. 4, a flowchart for an embodiment of a method 1000 performed via the controller 200 for sustaining the energy level of the WNA 300 is provided. It should be appreciated that multiple WNAs 300 may be position throughout the PGP 10 and proximate to one or more PGU 20 from which it receives one or more parameters. Additionally, one or more LFAs 400 may be position throughout the PGP 10 and operably within the purview of the WNAs 300, and more particularly, the PV panel 362.

In step 1010, receiving one or more messages, via the WNA 300, identifying one or more parameters of the PGU 20 and/or one or more parameters of the WNA 300. As described herein, the parameters of the PGU 20 may include one or more parameters identifying the operability or condition of the PGU 20 or its internal components. The one or more parameters of the WNA 300 may include parameters identifying the location of the WNA 300 within the PGP 10. The location may be identified by comparing, e.g., a serial number or other unique identifier for the WNA 300 to a floor plan of the PGP 10, or by other means known to persons having ordinary skill in the art and capable of identifying the location of the WNA 300. Additionally, the parameters may include an indication of the energy/power level remaining in the sensor power source 335 for the WNA 300, or in a further embodiment, another WNA 300.

In step 1020, identifying the energy remaining in the sensor power source 335. As described herein, the power level may be identified as a battery state, e.g., full, partial, etc., or as a value indicative of the percentage remaining, a range, or other numerical value. Upon identifying the energy remaining, the controller 200, under the control of the CAP 250, may compare the identified power level to, e.g., a listing or other database, to determine whether the remaining power is at or below a sustainable power threshold for the WNA 300. That is, to determine if the WNA 300 needs to be recharged. The listing may be stored within the controller 200, e.g., the memory 220, or any other storage medium operable connected thereto and accessible by the controller 200.

Upon determining that the WNA 300 needs recharging, in step 1030, activating the LFA 400. In this step, the controller 200, under the control of the CAP 250, activates an LFA 400 in response to the identified energy level. The activate LFA 400 may be position within the PGP 10 above or proximate to the WNA 300 to be recharged, such that the light energy LE emitted therefrom is within the line-of-sight of the PV Panel 362 of the WNA 300. In yet a further embodiment, the WNA 300 may identify which LFA 400 should be activated by the controller 200. This identification may be provided with the message identifying the energy level, or a subsequent message.

Upon determining that the sensor power source 335 is fully charged or no longer requires recharging, in step 1040, deactivating the LFA 400. In this step the controller 200, under the control of the CAP 250, may deactivate the LFA 400 upon determining that the energy within the sensor power source 335 is at or near its full capacity, or above the threshold requiring recharging of the sensor power source 335. To determine the power level, the controller 200 may receive a further message from the WNA 300 identifying its power level. Upon comparing this further identified power level with the listing, if the listing is above the threshold for recharging the sensor power source 335, the LFA 400 which was previously activate, may be deactivated.

In yet a further embodiment, the controller 200 or the LFA 400 may include a timing module or timer operable connected thereto for deactivating an activated LFA 400. The timing module may define a time or time period, e.g., one hour, half a day, for operating the activated LFA 400. In an embodiment where a specified deactivation time is defined, the specified time may correspond to the time represented by, e.g., a system clock for the controller 200 or any other device operably connected thereto. In this embodiment, and in addition to or in lieu of receiving the update message from the WNA 300 identifying the updated state of the sensor power source 335, the LFA 400 may be deactivated based upon the specified time or predetermined period as defined via the timing module. It should also be appreciated that the above functionality of the timing module may be comprised as a series of instructions of the CAP 250, which upon execution, via the processing circuit 210, causes the controller 200 to deactivate the activated LFA 400 based upon the specified time or time period via the CAP 250.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the terms “comprising”, “including”, and “having”, are open-ended and does not exclude other elements or steps; and the use of articles “a” or “an” does not exclude a plurality.

We claim:

1. A wireless monitoring system comprising:
a controller operably connected to a light emitting means; and
a wireless node assembly in operable communication with the controller and configured to transmit one or more parameters to the controller, one of the parameters identifying a power state of the wireless node assembly;
wherein the controller is configured to identify the power state from the one parameter and to activate the light emitting means in response to the identified power state;
wherein the activated light emitting means is configured to emit a light energy; and
wherein the wireless node assembly is configured to absorb the emitted light energy and convert the light energy into electricity for recharging the wireless node assembly.

2. The system of claim 1,
wherein the controller identifies the power state by monitoring the wireless node assembly.

3. The system of claim 1,
wherein the controller identifies the power state by receiving a message including the one parameter, via the wireless node assembly, and by parsing the message to identify the power state.

4. The system of claim 1,
wherein the power state represents that a power source of the wireless node assembly has a power level below the power source's power capacity.

5. The system of claim 1,
wherein the power state represents that a power level of the wireless node assembly is below a predetermined value.

6. The system of claim 1,
wherein the wireless node assembly comprises a sensor operably connected to a power module, and wherein the power module is configured to absorb and convert the emitted light energy into electricity, and to transmit the electricity to a power source of the sensor for recharging the power source.

7. The system of claim 5,
wherein the power module is a photovoltaic panel having one or more photovoltaic cells, and wherein the one or more photovoltaic cells absorb the emitted light energy.

8. The system of claim 1,
wherein the controller is further configured to deactivate the light emitting means after a predetermined amount of time.

9. The system of claim 8,
wherein the controller comprises a timer, and wherein the timer defines the predetermined amount of time.

10. The system of claim 1,
wherein the controller is further configured to deactivate the light emitting means in response to a second parameter identifying an updated power state.

11. The system of claim 11,
wherein the updated power state represents that a power source of the wireless node assembly has a power level at the power source's power capacity.

12. The system of claim 1,
wherein the light emitting means is a lighting fixture comprising one or more bulbs adapted to emit the light energy.

13. A distributed wireless monitoring system for use in a power generation plant having one or more power generation units, the system comprising:
a controller operably connected to a light emitting means within the power generation plant; and
a plurality of wireless node assemblies distributed throughout the power generation plant, wherein each wireless node assembly is in operable communication with the controller and is configured to transmit a message to the controller, the message identifying a parameter of the one or more power generation units, a power state of one of the plurality of wireless node assemblies;
wherein the controller is configured to identify the power state and location from the message, and to activate the light emitting means in response to the identified power state;
wherein the activated light emitting means is configured to emit a light energy therefrom, and is positioned within the power generation plant relative to the identified location such that the emitted light energy is in line-of-sight of the wireless node assembly; and
wherein the wireless node assembly is configured to absorb the emitted light energy and convert the light energy into electricity for recharging the wireless node assembly.

14. The system of claim 13,
wherein the wireless node assembly comprises a sensor operably connected to a photovoltaic panel, and wherein the photovoltaic panel absorbs and converts the emitted light energy into electricity, and transmits the electricity to a power source of the sensor for recharging the power source.

15. The system of claim 14,
wherein the power state represents that the power source has a power level below the power source's power capacity.

16. The system of claim 13,
wherein the power state represents that a power level of the wireless node assembly is below a predetermined threshold.

17. The system of claim 13,
wherein the controller is further configured to deactivate the light emitting means after a predetermined amount of time.

18. The system of claim 1,
wherein the controller is further configured to deactivate the light emitting means in response to a second message identifying an updated power state of the wireless node assembly.

19. The system of claim 18,
wherein the updated power state represents that a power source of the wireless node assembly has a power level at the power source's power capacity.

20. A method in a controller, under the control of a controller application, for sustaining a wireless node assembly of a monitoring system, comprising the steps of:
identifying a power state of the wireless node assembly;
determining if the identified power state represents that a power level of the wireless node assembly is within a predefined range to recharge the wireless node assembly; and
upon determining that the power level is within the predefined range, activating a light emitting means operatively connected to the controller, and in response to the determined power level, the light emitting means positioned relative to the wireless done assembly such that a light energy emitted from the light emitting means is within a line of sight of the wireless node assembly.

21. The method of claim 20,
wherein the light emitting means is a lighting fixture comprised of a plurality of bulbs adapted to emit the light energy.

22. The method of claim 20,
wherein the wireless node assembly comprises a sensor operably connected to a photovoltaic panel; and wherein the photovoltaic panel: absorbs the emitted light energy, converts the emitted absorbed light energy into electricity; and transmits the electricity to a power source of the sensor.
